(19) United States
(12) Patent Application Publication
(10) Pub. No.: US 2006/0233587 A1
(43) Pub. Date: Oct. 19, 2006

(54) Ink usage estimation from print run assets

(76) Inventors: Gary L. Vondran JR., San Carlos, CA (US); Luca Chiarabini, San Diego, CA (US); Galo Gimenez, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/106,963

(22) Filed: Apr. 14, 2005

(51) Int. Cl. B41J 2/175; B41J 29/42

(52) U.S. Cl. 400/703; 347/7

(57) ABSTRACT

An ink usage estimate is based on assets of a print run. Examples of the assets include, without limitation, backgrounds, images, logos, graphics, and text. The estimates may be made from full size renditions of the assets or from thumbnails of the assets or both.

### BACKGROUND

Large print runs of variable data can easily have tens of thousands of images, where the images are composed of different combinations of data, print elements, figures, text, etc. Hundreds of thousands of sheets can be printed during a large print run.

The print runs can be printed with large format inkjet printers, industrial laser printers, and digital presses, using inks of different colors. Hundreds of gallons of ink could be used during a large print run.

If ink runs out during a large print run, it is unlikely that the ink can be replenished immediately. Typically, a rush order has to be placed in order to replenish the ink. Several days might elapse before the ink is replenished. During that time, the printing comes to a halt. Equipment and workers become idle, and the print run is delayed.

Ink shortages can be avoided by grossly overstocking ink. However, this approach can be very expensive.

Ink shortages can be avoided instead by estimating ink usage prior to printing. For repetitive, static print runs, different images can be printed, ink usage per color plane per print can be measured, and the usage per color plane can be multiplied by the total number of prints.

However, this approach is impractical for large variable data print runs. It can be impractical in terms of time and cost to print out thousands of different images and measure the ink actually used in the prints.

Accurate ink usage estimates for large print runs, without making prints and measuring the ink actually used on the prints, would be desirable.

### SUMMARY

According to one aspect of the present invention, a method of estimating ink usage for a print run includes estimating ink coverage from assets of the print run. According to another aspect of the invention, the ink usage is estimated from thumbnails of the print run assets.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a method of estimating print run ink usage in accordance with an embodiment of the present invention.

FIGS. 2 and 3 are illustrations of methods of using the ink usage estimates in accordance with embodiments of the present invention.

FIGS. 4-6 are illustrations of different systems in accordance with embodiments of the present invention.

### DETAILED DESCRIPTION

As shown in the drawings for purposes of illustration, the present invention is embodied in ink usage estimates for print runs. A print run utilizes a plurality of assets. These assets include without limitation backgrounds, images, logos, and other variable data (e.g. images, graphics, text). In large variable data print runs, the assets are typically re-used. Different arrangements of assets within the print run are referred to as “versions.” An Ink usage estimate according to the present invention exploits this-re-use. The ink usage estimate is determined from assets of the print run.

The ink usage estimate is useful for small, static print runs, since it offers a relatively inexpensive way of estimating ink usage. However, the method is especially useful for large variable data print runs, where it is impractical to print out all of the unique versions and measure ink coverage.

Consider the following example of a large variable data print run: a print run for a network of retail stores. The print run includes thousands of print batch jobs. These batch jobs include price and sale tags to be placed with their respective products along the shelves. The price tags have pictures of the products so it is easier to recognize the exact product it is associated with. Each job is personalized or versioned toward a target retail store, item, local and regional demographics, and even store aisle and shelf. In addition to containing different text (content), different jobs might use different backgrounds, templates, images, and graphics. The jobs might be printed on paper, canvas, or other types of print media. Generating the print run requires gathering diverse types of information, and composing jobs from combinations of thousands of images, tens of backgrounds, and numerous page sizes. Millions of sheets are printed out in typical print runs. Grossly overstocking ink for a job of this magnitude can be prohibitively expensive. On the other hand, running out of ink can be prohibitively expensive. The ink usage estimate according to the present invention ensures that such an enormous variable data print run will be printed without running out of ink and without grossly overstocking ink.

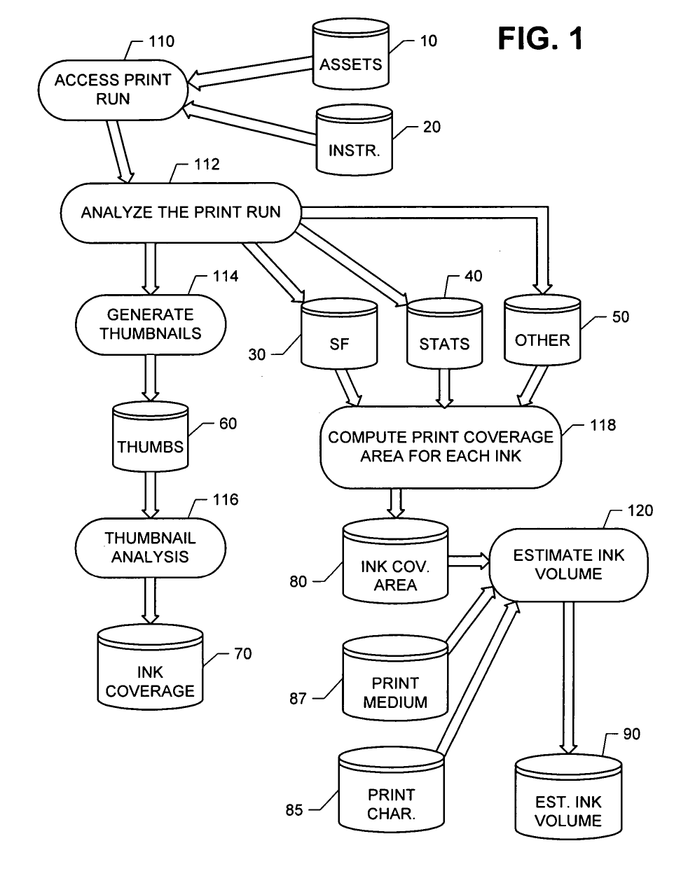

Reference is made to FIG. 1, which illustrates a method of estimating ink usage for a print run. The print run may be generated in advance of the ink usage estimate. It not limiting to the invention as to who generates the print run or how the print run is generated. Approaches towards gathering the information may vary widely, but in general all approaches ensure that all pieces have been collected before estimating the ink usage. The print run may be generated in whole or in part by a customer, a graphics designer, a print shop, or another party. Typically the content is driven from a database with associated image repository. Graphic artists, for example, usually create the templates that will be used over a period of runs.

At step 110, the print run is acquired. The print run may be made available as set of assets 10 and instructions 20. For example, a language such as PPML may be used to indicate how the assets 10 should be combined.

At step 112, the print run is analyzed. The analysis includes determining scale factors 30 for the assets 10. Typically, the assets are presented at a certain size and resolution. When placed within a template, the assets are commonly scaled to fit the space. Each scale factor 30 indicates how much the full size asset 10 will be scaled when put in a template.

The analysis also includes generating statistics 40 about the assets. The statistics 40 for an asset 10 include the number of times that asset 10 will be used in a print run at a given scale factor 30. The statistics may also include whether an asset 10 is scaled up or down.

During analysis, other factors 50 that affect ink usage may be considered. For instance, ink usage may be reduced by the amount of cropping that will be performed on an image. Other factors that can reduce ink usage include transparency and overlap of assets.

Text is generally not included with the assets 10; however, it may be included as a rough constant factor since its effective coverage is usually quite small. It has been found that text regions do not have a significant affect on the amount of ink usage. Thus, the ink usage estimate can exclude the amount of ink needed for text regions. Still, thumbnails of text regions could be generated and used to estimate the ink usage.

At step 114, thumbnails 60 of all assets 10 in the print run are acquired. The thumbnails 60 are subsamples of the full size assets 110. For example, a full page asset at 600 dpi might require 100 MB of memory, whereas a thumbnail at 60 dpi and at one-tenth the size of the full size asset might require only a few kilobytes of storage. Even though the thumbnails 60 have a much lower resolution than the full size assets, they typically have the same general color distribution as the full size assets. This observation will be exploited.

Some or all thumbnails 60 may be acquired from a library of thumbnails that were previously generated or presently available. Some or all thumbnails 60 may be created ahead of time by using a commercially available tool such as ImageMagik (which is available with most Linux distributions). Some or all thumbnails 60 may be supplied along with assets 10. Some or all thumbnails 60 may even be obtained by extracting asset command streams from the file jobs Typical print job file formats are PPML or PDF. Commercially available tools such as Adobe Acrobat® and Ghostscript (which is available with most Linux distributions) can be used to extract out the thumbnails from these file formats.

At step 116, the thumbnails 60 are analyzed. The analysis includes determining ink coverage area 70 for each thumbnail 60. Ink coverage area for an asset 10 may be determined by converting the thumbnail 60 to the target printer's color space. For example, an image may be presented in RGB (Red, Green, Blue) color space and converted to a four-ink CMYK (Cyan, Magenta, Yellow, Black) color space, or a six-ink color space that includes CMYK and light cyan and light magenta, or a color space having seven or more colors (e.g., a color space that includes specialized “spot” colors). Conventional halftoning techniques such as dithering may be used to convert the asset into halftone patterns of black, cyan, magenta and yellow pixels. The ink coverage for each color plane may be computed by dividing the number of lit pixels to the total number of pixels, or by simply summing all pixel values across a color plane for the entire page.

At step 118, for each color plane, the ink coverage area 80 of the entire print run is computed. The ink coverage 80 may be computed according to equations (1) and (2) below. For each asset 10, the ink coverage area per color plane may be computed as follows:

$${a}_{j , k} = {\sum }_{i = 1} \frac{{ω}_{i} {t}_{j , k}}{{SF}_{i}} \qquad ( 1 )$$

where a_{j,k} is the ink coverage area of the k^{th} color plane of the j^{th} asset, t_{j,k} is the ink coverage area of the corresponding j^{th} thumbnail, and

$$\frac{{ω}_{i}}{{SF}_{i}}$$

is the frequency ωᵢ that the j^{th} asset thumbnail occurs at the i^{th} scale factor SFᵢ.

The total ink coverage per color plane (aₖ) may be computed as follows

$${a}_{k} = {\sum }_{j = 1}^{N} {a}_{j , k} \qquad ( 2 )$$

where N is the total number of assets.

At step 120, the estimated volume 90 of ink per color plane is computed. The estimated volume 90 per color plane may be estimated as a function of the estimated ink coverage area per color plane 80 and printing characteristics 85. The printing characteristics 85, which are specific to the print device, include the ink volume per unit area. The estimated volume for each color plane may be computed as a product of the ink coverage area 80 and the volume per unit area. The ink volume is generally linear with respect to area, so simply multiplying by a constant is probably good enough for most cases. If more detailed information is needed or the printing really is non-linear, then an equation or function can be used to generate the ink volume per unit area conversion factor.

The estimated ink volume 90 may also be computed as a function of the type of print media 87. The volume of ink per unit area coverage may be dependent upon the print media. Thus, the estimations at steps 118 and 120 can adjust the ink volume and coverage area according to the print media.

The method is extremely efficient, since it exploits the re-use of the assets. Ink coverage area of each asset may be computed only once. The method provides a better idea of ink availability, turnaround time, cost, etc. The estimate contributes to a higher grade of service.

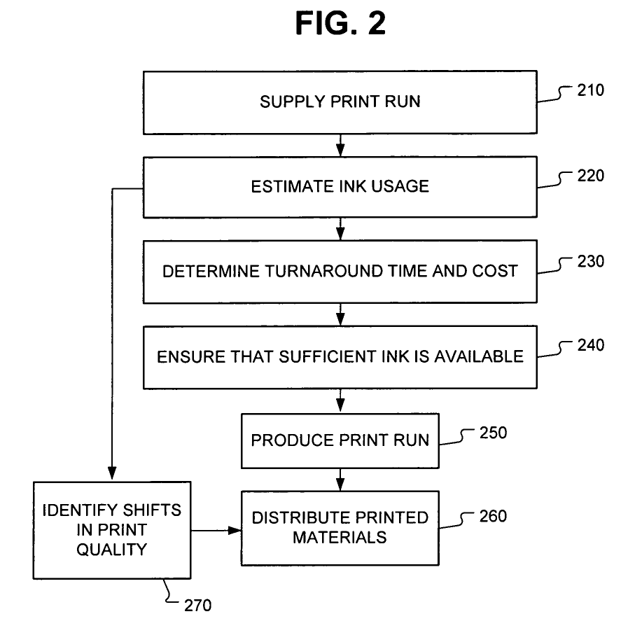

Reference is made to FIG. 2, which provides an example of how the ink usage estimate can be used. At block 210, a customer supplies files of assets and instructions that describe a variable data print run. The customer can also supply thumbnails of the assets.

At block 220, ink usage is estimated according to the present invention. The ink usage may be estimated as shown in FIG. 1.

At block 230, a turnaround time and cost for the print run are determined. The turnaround time and cost are based in part on the amount of ink needed, whether the ink is in stock and, if not, how long it would take to obtain the ink. The turnaround time and cost are relayed to the customer.

Assuming the customer agrees with the turnaround time and cost, steps are taken to ensure that sufficient ink is available to complete the print run (block 240). In this example, the ink usage estimate provides an upper and lower bound on the amount of ink needed. In addition to ensuring that sufficient ink is available for the print run, the estimate also ensures that the ink not grossly overstocked.

Once sufficient ink is available, the print run is produced (block 250), and the printed materials are distributed to the customer (block 260).

The ink usage estimate can also be used to detect shifts in print quality (270). For example, a printer might be identified as faulty or in need of maintenance if the amount of ink actually used is substantially different than the estimated ink usage.

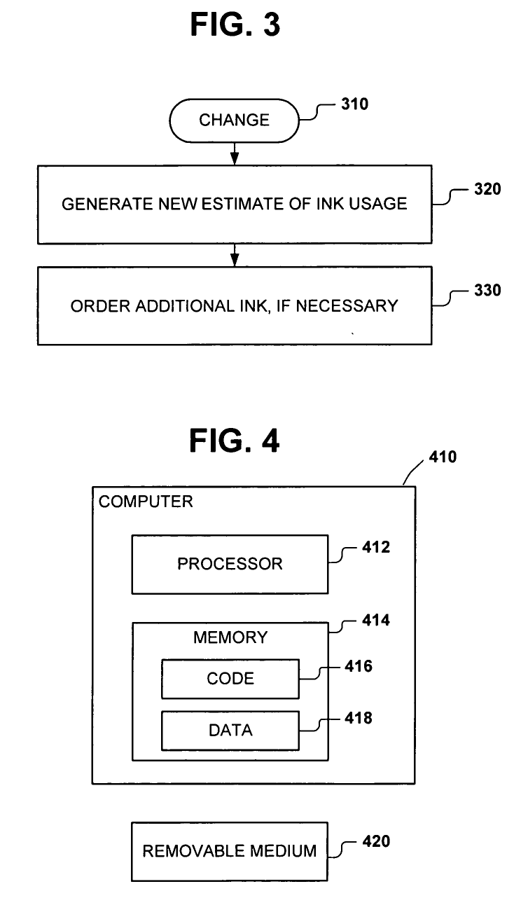

Reference is now made to FIG. 3. If a change is made to a print run (block 310), a new ink estimate can be computed quickly and automatically (block 320) and additional ink is ordered, if necessary (block 330). For example, if a background is changed, only the ink coverage area of the new background needs to be determined. Assuming that frequency and scale factor of the background remains constant, only the new ink coverage area per plane needs to be updated. The new estimated volume per ink can then be computed.

If the target printer is changed, only the ink volume per area coverage needs to be updated (provided that the native color space doesn't change). The new estimated volume per ink can then be computed.

A method according to the present invention is not limited to the use of thumbnails to determine ink coverage. Ink coverage could be estimated partially or entirely from full size images of assets. The use of full size assets would give a more accurate estimate of ink coverage, and it would eliminate the need for thumbnails. However, the use of full size assets would increase memory requirements and computational burden, since the full resolution image files will usually be several orders of magnitude larger than thumbnail files. Moreover, it has been found that the thumbnails provide sufficient accuracy.

Reference is now made to FIG. 4, which shows an exemplary system for estimating ink usage. The system includes a computer 410 having a processor 412 and memory 414. The memory 414 stores code 416 that, when executed, causes the processor 412 to receive and analyze a print run, and estimate ink usage for the print run.

The system may also generate the print run. The computer 410 may access print run data 418 that includes, but is not limited to, the asset thumbnails, scale factors, frequency statistics, and information about printing characteristics.

The code 416 may be generated (e.g., compiled) and used on the same computer or it may be generated on one computer and distributed to other machines. The code 416 can be distributed (e.g., sold commercially) in any number of ways. For example, the code 416 can be distributed via a removable medium 420 such as an optical disc (e.g., DVD) or transmitted (e.g., as an installable package over a network) from memory of one machine to another.

The code 416 may be incorporated as an application plug-in, integrated into a print driver, or run as a standalone application.

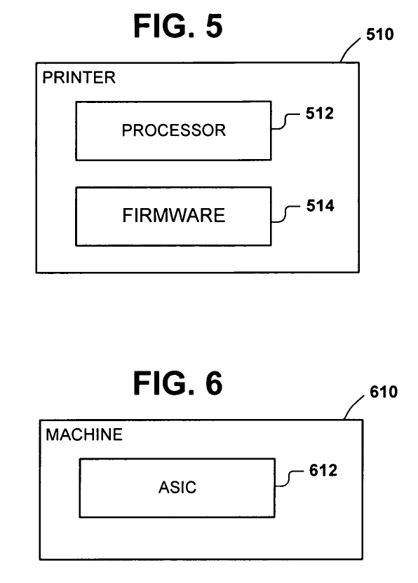

A system according to the present invention is not limited to a computer. The system of FIG. 5 includes a printer 510 having a processor 512 and firmware 514. The code according to the present invention is embedded in a printer's firmware 514.

The system of FIG. 6 includes a machine 610 having an application specific integrated circuit (ASIC) hardware chip 612 that is designed to estimate ink usage in accordance with the present invention.

Although specific embodiments of the present invention have been described and illustrated, the present invention is not limited to the specific forms or arrangements of parts so described and illustrated. Instead, the present invention is construed according to the following claims.

1. A method of estimating ink usage for a print run, the method comprising estimating ink coverage from print run assets.

2. The method of claim 1, wherein the ink coverage is estimated from thumbnails of the assets.

3. The method of claim 1, wherein estimating the ink coverage of an asset includes converting the asset to printer native color space and determining area coverage for each color plane of the native color space.

4. The method of claim 3, further comprising accumulating ink coverage area for the assets based thumbnail coverage area, and asset occurrence at different scale factors.

5. The method of claim 3, further comprising estimating ink volume as a function of ink coverage per color plane and printer ink volume per unit area.

6. The method of claim 6, wherein the ink volume is also estimated as a function of print media.

7. The method of claim 1, wherein text is treated as a rough constant factor.

8. The method of claim 1, wherein the estimated ink usage is used to detect shift in print quality.

9. The method of claim 1, wherein the estimated ink usage is used to determine turnaround time and print cost.

10. The method of claim 1, wherein the estimated ink usage is used to set ink usage bounds.

11. A system comprising:
means for accessing a plurality of assets in a print run; and
means for estimating ink usage for the print run, the ink usage estimated from the assets.

12. Apparatus for a variable data print run, the apparatus comprising a processor for estimating ink usage prior to print run production, the usage estimated from assets of the print run.

13. The apparatus of claim 12, wherein the processor estimates ink coverage from thumbnails of the assets.

14. The apparatus of claim 12, wherein estimating the ink coverage of an asset includes converting the asset to printer native color space and determining area coverage for each color plane of the native color space.

15. The apparatus of claim 14, wherein the processor accumulates ink coverage area for the assets based thumbnail coverage area, and asset occurrence at different scale factors.

16. The apparatus of claim 12, wherein the processor estimates ink volume as a function of ink coverage per color plane and printer ink volume per unit area.

17. The apparatus of claim 12, wherein text is treated as a rough constant factor.

18. The apparatus of claim 12, wherein the processor uses estimated ink usage to detect shift in print quality.

19. The apparatus of claim 12, wherein the processor uses estimated ink usage to determine turnaround time and print cost.

20. The apparatus of claim 12, wherein the processor uses estimated ink usage to set ink usage bounds.

21. An article for a processor, the article comprising:
memory encoded with data for causing the processor to estimate ink usage prior to printing a print run, the usage estimated from assets of the print run.

22. The article of claim 21, wherein the ink coverage is estimated from thumbnails of the assets.

23. The article of claim 21, wherein estimating the ink coverage of an asset includes converting the asset to printer native color space and determining area coverage for each color plane of the native color space.

24. The article of claim 23, wherein the data further causes the processor to accumulate ink coverage area for the assets based thumbnail coverage area, and asset occurrence at different scale factors.

25. The article of claim 21, wherein the data further causes the processor to estimate ink volume as a function of ink coverage per color plane and printer ink volume per unit area.

26. The article of claim 21, wherein text is treated as a rough constant factor.

27. The article of claim 21, wherein the estimated ink usage is used to detect shift in print quality.

28. The article of claim 21, wherein the estimated ink usage is used to determine turnaround time and print cost.

29. The article of claim 21, wherein the estimated ink usage is used to set ink usage bounds.

30. Apparatus for a variable data print run, the apparatus comprising the article of claim 21.
